(19) United States
(12) Patent Application Publication
(10) Pub. No.: US 2026/0348210 A1
(43) Pub. Date: Nov. 5, 2026

(54) Lockout Device

(71) Applicant: Reece Safety Products International Inc., Houston, TX (US)

(72) Inventors: Alec J. Graham, Dallas, TX (US); Andrew J. Graham, Ilkley (GB)

(21) Appl. No.: 19/195,592

(22) Filed: Apr. 30, 2025

(51) Int. Cl. E05C 19/18; E05B 67/00; F16G 11/04

(52) U.S. Cl. CPC E05C 19/188; E05B 67/003; F16G 11/04

(57) ABSTRACT

A lockout device for securing a door panel of an electrical service box includes a housing; a flexible cable that is slidably disposed within the housing having a first end, a second end, and a middle portion; a first retaining tab coupled to a first end of the housing; a second retaining tab coupled to a second end of the flexible cable; a cam disposed within the housing for changing the lockout device from a locked state to an unlocked state; at least two wedges disposed within the housing proximate to the cam; and at least one spring disposed within the housing proximate to the at least two wedges for urging at least two wedges toward the cam.

When in the locked state, the at least two wedges clamp the flexible cable to prevent the flexible cable from sliding relative to the housing in at least one direction.

### TECHNICAL FIELD

This application is directed, in general, to lockout devices, and more specifically to safety lockout devices to lockout electrical panels.

### BACKGROUND

The following discussion of the background is intended to facilitate an understanding of the present disclosure only. It should be appreciated that the discussion is not an acknowledgement or admission that any of the material referred to was part of the common general knowledge at the priority date of the application.

Lockout devices are often used to secure electrical service boxes that contain switches, breakers, or other methods of turning off electrical power to equipment or machinery. For worker safety, lockout devices are used to prevent access to the switches or breakers while work, such as maintenance or repairs, is being performed on the equipment or machinery. The lockout devices prevent accidentally supplying power to the equipment or machinery while it is undergoing maintenance or repairs, which may cause damage to the equipment or machinery or bodily harm to the workers performing the maintenance or repairs.

While lockout devices are known, improvements are desired.

### SUMMARY

According to an illustrative embodiment a lockout device, for securing a door panel of an electrical service box includes a housing having a first side and a second side; a flexible cable having a first end, a second end, and a middle portion; a first retaining tab coupled to the first end of the housing; a second retaining tab coupled to the second end of the flexible cable; a cam disposed within the housing for changing the lockout device from a locked state to an unlocked state; two wedges disposed within the housing proximate to the cam; and a spring disposed within the housing proximate to the pair of wedges for urging the pair of wedges toward the cam. A first aperture is formed through the housing on the first side of the housing. A second aperture is formed through the housing on the second side of the housing. At least a portion of the middle portion is disposed within the first aperture, the housing, and the second aperture. The flexible cable is partially disposed between the two wedges.

According to an illustrative embodiment a lockout device for securing the door of an electrical service box includes a housing; a flexible cable partially disposed within the flexible housing and slidably retained within the housing to allow the flexible cable to slide in a first direction and in a second direction; a first retainer coupled to the housing; a second retainer coupled to the second end of the flexible cable; at least two wedges disposed within the housing forming a channel between the at least wedges; and a cam disposed within the housing proximate to the at least two wedges for changing the state of the lockout device from locked to unlocked. The flexible cable has a first end and a second end. When the flexible cable slides in the first direction, a distance between the housing and the second end of the flexible cable decreases, and, when the flexible cable slides in the second direction, the distance between the housing and the second end of the flexible cable increases. The flexible cable is partially disposed within the channel between the at least two wedges. When the lockout device is locked, the flexible cable is able to slide relative to the housing in the second direction but not in the first direction, and when the lockout device is unlocked, the flexible cable is able to slide in the second direction and the first direction.

According to an illustrative embodiment a lockout device for securing the door of an electrical service box includes a housing; a flexible cable retained by the housing and slidably disposed within the housing; a first locking wedge disposed within the housing; a second locking wedge disposed within the housing; and a rotatable knob coupled to an exterior of the housing. The first locking wedge and the second locking wedge each have a substantially flat planer face. The flat planer face of the first wedge faces the flat planer face of the second wedge to form a cavity between the flat planer face of the first wedge and the flat planer face of the second wedge. The flexible cable is partially disposed within the cavity between the flat planer face of the first wedge and the flat planer face of the second wedge. Rotation of the knob changes a state of the lockout device from unlocked to locked or from locked to unlocked. When the lockout device is in the locked state, the first wedge and the second wedge contact the flexible cable to prevent the flexible cable from sliding within the housing in a least one direction.

Other embodiments are disclosed.

### DESCRIPTION OF THE DRAWINGS

Illustrative embodiments of the present disclosure are described in detail below with reference to the attached drawing figures, which are incorporated by reference herein and wherein:

FIG. 1 is a schematic, elevation view of an illustrative embodiment of a lockout device installed on an electrical panel box;

FIG. 1A is a schematic, perspective view of a portion of an illustrative embodiment of a lockout device installed on an electrical panel box;

FIG. 1B is a schematic, perspective view of a portion of an illustrative embodiment of a lockout device installed on an electrical panel box;

FIG. 2 is a schematic, elevation view of an illustrative embodiment of a lockout device installed on an electrical panel box;

FIG. 2A is a schematic, perspective view of a portion of an illustrative embodiment of a lockout device installed on an electrical panel box;

FIG. 2B is a schematic, perspective view of a portion of an illustrative embodiment of a lockout device installed on an electrical panel box;

FIG. 3 is a schematic, top view of an illustrative embodiment of a lockout device;

FIG. 4 is a schematic, cross-sectional view of the illustrative embodiment of a lockout device taken on line F4 as indicated on FIG. 3;

FIG. 5 is a schematic, exploded perspective view of an illustrative embodiment of a lockout device;

FIG. 6 is a schematic, exploded perspective view of an illustrative embodiment of a lockout device;

FIG. 7 is a schematic, exploded perspective view of an illustrative embodiment of a lockout device;

FIG. 8 is a schematic, detailed exploded perspective view of a portion of an illustrative embodiment of a lockout device; and

FIG. 9 is a schematic, exploded perspective view of an illustrative embodiment of a lockout device.

### DETAILED DESCRIPTION

In the following detailed description of the preferred embodiments, reference is made to the accompanying drawings that form a part hereof, and in which is shown, by way of illustration, specific embodiments in which the disclosure may be practiced. These embodiments are described in sufficient detail to enable those skilled in the art to practice the disclosure, and it is understood that other embodiments may be utilized, and that logical structural, mechanical, electrical, and chemical changes may be made without departing from the spirit or scope of the disclosure. To avoid detail not necessary to enable those skilled in the art to practice the disclosure, the description may omit certain information known to those skilled in the art. The following detailed description is, therefore, not to be taken in a limiting sense, and the scope of the present disclosure is defined only by the claims. Unless otherwise indicated, as used throughout this document, “or” does not require mutual exclusivity.

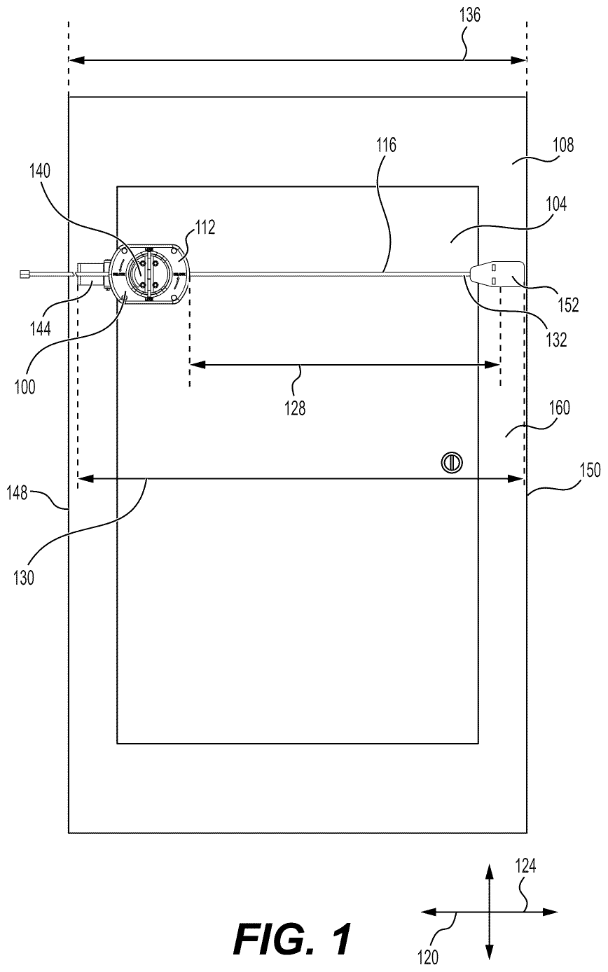

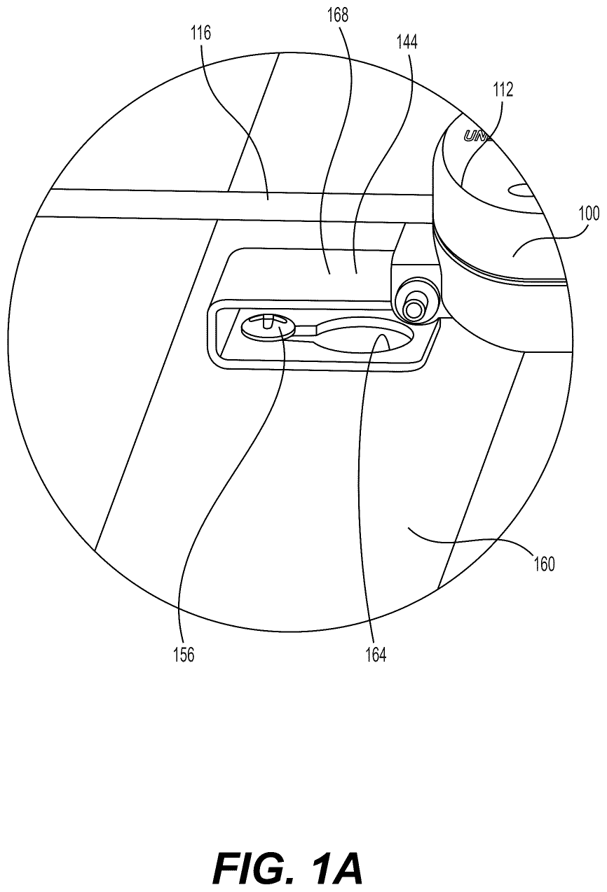

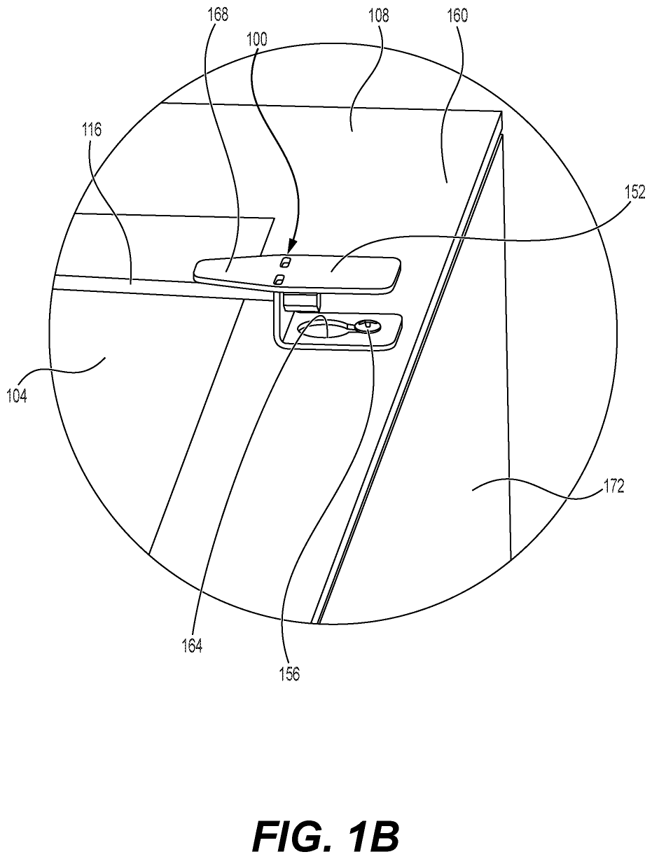

Referring initially to FIG. 1, an illustrative embodiment of a lockout device 100 will be described. The lockout device 100 is used to secure a door 104 of an electrical service box 108. The electrical service box 108 may be any box that contains electrical devices for turning on or off electricity flow to a device or machinery. For example, the electrical service box 108 may be an electrical panel box containing circuit breakers or may be a housing containing electrical switches or toggles.

The lockout device 100 is secured to the electrical box 108 so that the door 104 cannot be opened far enough for a person to access switches or breakers contained within the electrical service box 108.

The lockout device has a housing 112. A flexible cable 116 is slidably disposed within the housing 112 so that the flexible cable 116 can slide within the housing 112, relative to the housing 112, in a first direction 120 and in a second direction 124. When the flexible cable 116 slides within the housing in the first direction 120 a distance 128 between the housing 112 and a second end 132 of the flexible cable 116 decreases. When the flexible cable 116 slides within the housing in the second direction 124 a distance 128 between the housing 112 and the second end 132 of the flexible cable 116 increases. In this manner, the effective length 130 of the lockout device 100 may be varied to match a width 136 of the electrical service box 108 to properly secure the door 104 when installed.

The flexible cable 116 made be made from any material having sufficient strength to prevent easy removal or breakage of the flexible cable 116 when the lockout device 100 is installed on the electrical service box 108. For example, the flexible cable 116 may be made from coated or uncoated stranded or braided wire. The flexible cable 116 may have any length appropriate for spanning across the electrical service box 108. In some embodiments, the length of the flexible cable 116 is in the range of 1-5 feet in length. In some embodiments, the length of the flexible cable is approximately 1 meter or 1 yard.

The housing 112 of the lockout device 100 contains a locking mechanism, which is discussed in more detail below, to change the state of the lockout device 100 from a locked state to an unlocked state, and vice versa. A user of the lockout device 100 may change the state of the lockout device from locked to unlocked and vice versa by rotating a knob 140 which is coupled to the housing 112.

When the lockout device 100 is in the unlocked state, the flexible cable 116 is able to slide in both the first direction 120 and the second direction 124, relative to the housing 112.

When the lockout device 100 is in the locked state, the flexible cable 116 is only able to slide in the first direction 120 relative to the housing 112 and is prevented from sliding in the second direction 124, relative to the housing. In this manner, the effective length 130 of the lockout device 100 may be adjusted to be both longer and shorter when the lockout device 100 is unlocked, and the effective length 130 of the lockout device 100 may only be decreased when the lockout device 100 is locked. Thereby, when installed onto the electrical service box 108 and locked, the lockout device 100 may not be loosened in a manner that would allow opening of the door 104 but may be tightened to more securely prevent opening of the door 104.

A first retainer 144 is coupled to the housing 112 of the lockout device 100. The first retainer 144 is used to couple to the lockout device 100 to a first side 148 of the electrical service box 108. A second retainer 152 is used to couple the second end 132 of the flexible cable 116 to a second side 150 of the electrical service box 108. The first retainer 144 and second retainer 152 may each be coupled in different manners to the electrical service box 108.

A first method of coupling the first retainer 144 and second retainer 152 to the electrical service box 108 is depicted in FIGS. 1, 1A, and 1B. When coupled in this manner, the lockout device 100 takes advantage of screws 156 of the electrical service box 108. Many electrical service boxes 108 include screws 156 on the front face 160 of the electrical service boxes 108. Screws 156 are often used to couple the front face 160 of the electrical service boxes 108 to the other components of the electrical service boxes 108.

Each of the first retainer 144 and the second retainer 152 include a key hole slot 164 for coupling the first retainer 144 or the second retainer 152 to the electrical service box 108.

FIGS. 1A and 1B, respectively, show the first retainer 144 and the second retainer 152 coupled to the electrical service box 108 by the screws 156. A user desiring to use the lockout device 100 to secure the door 104 first backs out each screw 156 from the front face 160 of the electrical service box 108. Each screw 156 is backed out far enough so that the screws 156 maybe inserted into and retained by the key hole slots 164 of each of the first retainer 144 and the second retainer 152. In this manner, the lockout device 100 is secured to the electrical service box 108 to prevent access to switches or breakers located behind the door 104.

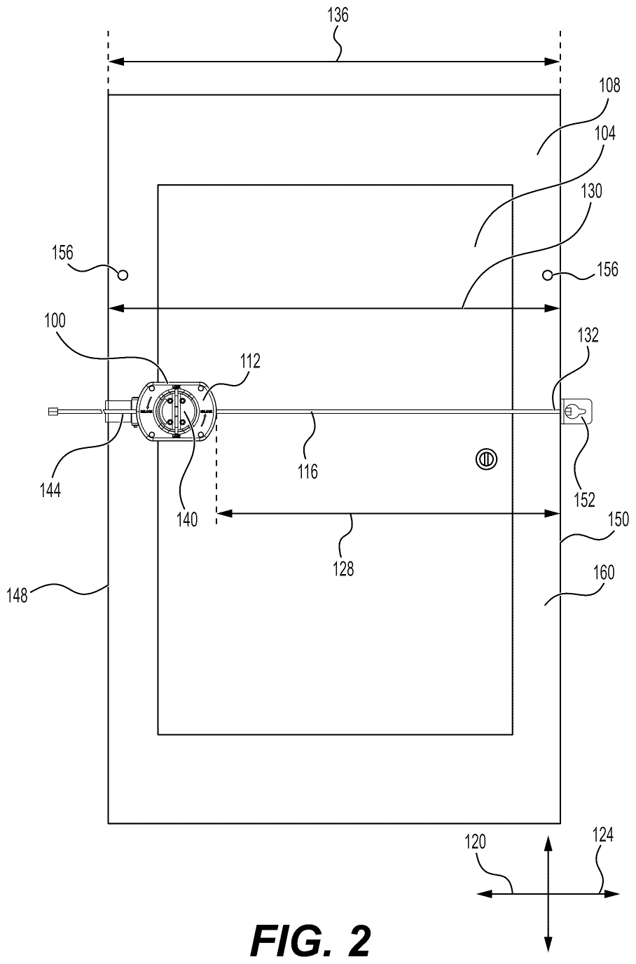

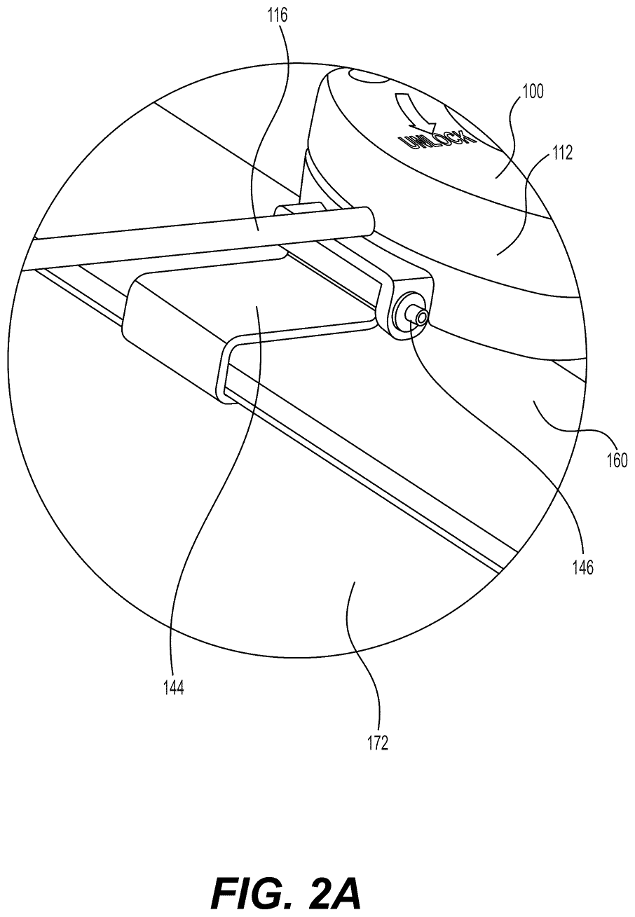

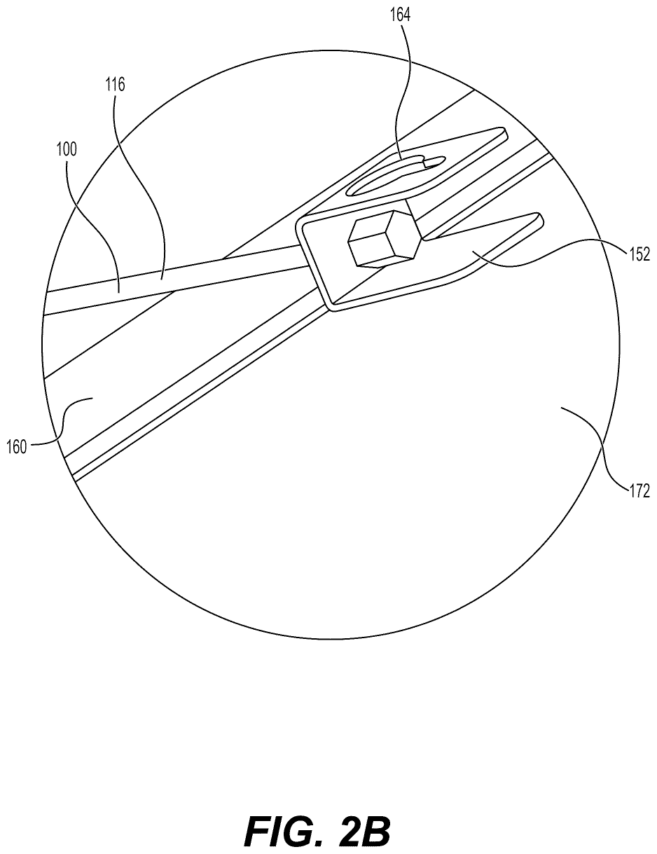

FIGS. 2, 2A, and 2B depict a second method of securing the lockout device 100 to the electrical service box 108. This method may be used when the screws 156 are not present or are not accessible. Each of the first retainer 144 and the second retainer 152 include a hook or tab 168 (visible in FIGS. 1A and 2A). The tab 168 of each of the first retainer 144 and the second retainer 152 is inserted between the front face 160 of the electrical service boxes 108 and a sidewall 172 of the electrical service boxes 108. In this manner, the lockout device 100 may be used to securely prevent the door 104 of the electrical service box 108 from opening without using the screws 156.

When the lockout device 100 is coupled to the electrical service box 108, by either manner described, the lockout device 100 is secured by the use of a safety padlock. The safety padlock is being applied to the lockout device 100, whilst in the lockable state, to actually deem the device as then being locked and secured.

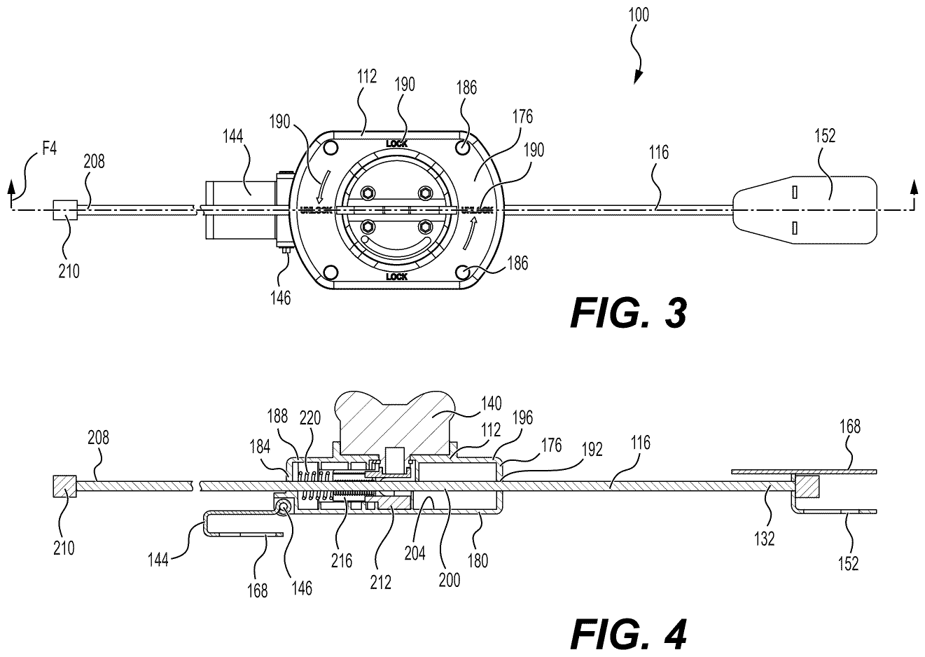

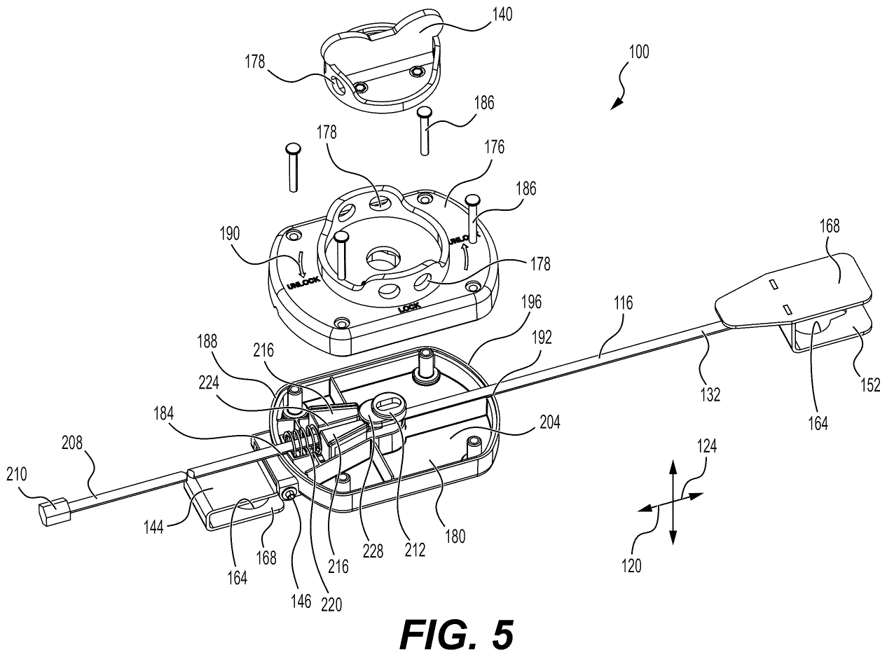

Referring now to FIG. 3, additional features of the illustrative embodiment of the lockout device 100 will be discussed. The housing 112 is formed of a front cover 176 and a back cover 180 (FIGS. 4 and 5). The front cover 176 is coupled to the back cover 180 by screws or pins 186 to form the housing 112. The front cover 176, which is visible to users when the lockout device is in use, may features markings 190 to help indicate the locked or unlocked status of the lockout device 100 or the direction that knob 140 should be rotated to change the status between locked and unlocked or vice versa.

Referring now to FIGS. 4 and 5, and primarily to FIG. 4, additional features of the illustrative embodiment of the lockout device 100 will be discussed with a focus on the internal components of the lockout device 100. As discussed above, the flexible cable 116 is slidably retained within the housing 112. A first aperture 184 is formed through the housing on a first side 188 of the housing 112. A second aperture 192 is formed through the housing 112 on a second side 196 of the housing 112.

The flexible cable 116 passes through and is partially disposed within the first aperture 184 and the second aperture 192. The flexible cable 116 is captured and retained by the first aperture 184 and the second aperture 192. However, the flexible cable is able to slide through both the first aperture 184 and the second aperture 192.

A middle portion 200 of the flexible cable 116 is disposed within an interior cavity 204 of the housing 112, so that at least a portion of the flexible cable 116 is disposed within the interior cavity 204 of the housing 112. A first end 208 of the flexible cable 116 and the second end 132 of the flexible cable 116 are disposed outside of the interior cavity 204 of the housing 112. A retainer 210 is coupled to the first end 208 of the flexible cable 116. The retainer 210 is sized and configured to prevent the first end 208 of the flexible cable 116 from entering into the interior cavity 204 of the housing 112 through the first aperture 184.

The first retainer 144 is coupled to the housing 112 by a hinge pin 146. This coupling allows for the first retainer 144 to rotate about the hinge pin 146 and therefore provides a hinged connection between the first retainer 144 and the housing 112. A hinged connection, such as shown, may allow for easier attachment of the lockout device 100 to the electrical service box 108. In other embodiments, the connection between the first retainer 144 and the housing 112 may be a fixed non-hinged connection.

As discussed in more detail below in relation to FIG. 5, a cam 212, at least two wedges 216, and a spring 220 are disposed within the housing 112. The middle portion 200 of the flexible cable 116 that is disposed within the interior cavity 204 of the housing 112 is partially disposed and passes through the cam 212, an opening 224 (FIG. 5) between the wedges 216, and through the spring 220.

Referring now primarily to FIG. 5, additional features of the illustrative embodiment of the lockout device 100 will be discussed. FIG. 5 depicts an exploded view of the lockout device 100 in the unlocked state. A discussed above, when the lockout device 100 is unlocked, the flexible cable 116 is free to slide in both the first direction 120 and the second direction 124, relative to the housing 112.

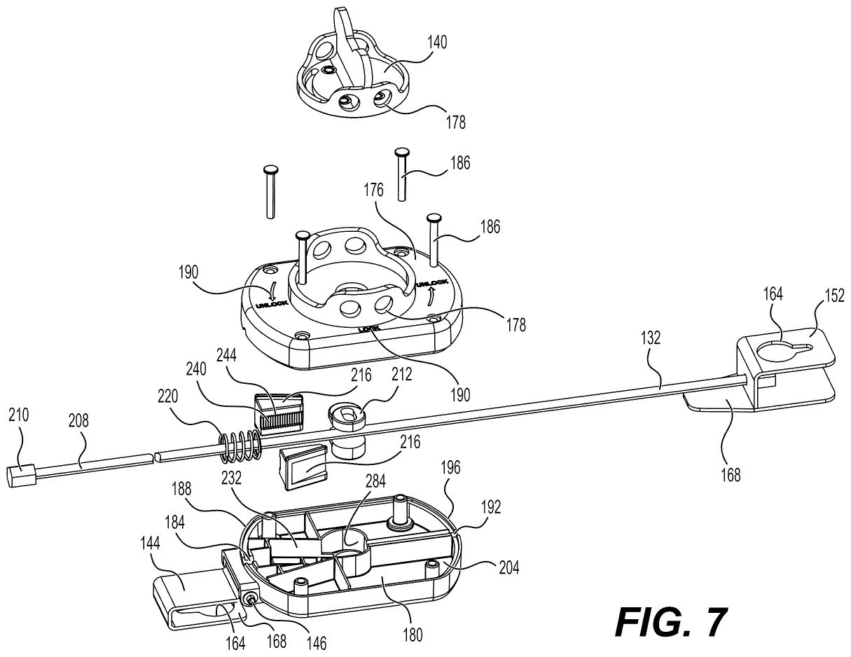

In the unlocked state, the cam 212 is rotated so that a lobe 228 of the cam 212 is in contact with the wedges 216. The contact between the lobe 228 of the cam 212 and the wedges 216 results in the cam 212 urging the wedges 216 in the first direction 120. The wedges 216 are captured by, but slidably disposed within, a wedge cavity 232 (FIG. 7), which allows the wedges 216 to move within the wedge cavity 232 in the first direction 120 and the second direction 124. The wedges 216 are disposed within the wedge cavity 232 so that they form the opening 224 between the wedges 216. A portion of the flexible cable 116 passes through the opening 224 and between the wedges 216.

The spring 220 is disposed proximate to the wedges 216. The spring 216 is operable to urge the wedges 216 in the second direction 124. When the lockout device 100 is in the unlocked state, the action of the lobe 228 of the cam 212 overcomes the urging forces of the spring 220 so that the wedges 216 move in the first direction 120 and the spring 220 is compressed, relative to the locked state. The action of moving the wedges 216 in the first direction 120 also causes the opening 224 between wedges 216 to become wider, relative to the locked state, so that the wedges 216 do not capture the flexible cable 116 in a manner that prevents the flexible cable 216 from sliding in the first direction 120 or the second direction 124.

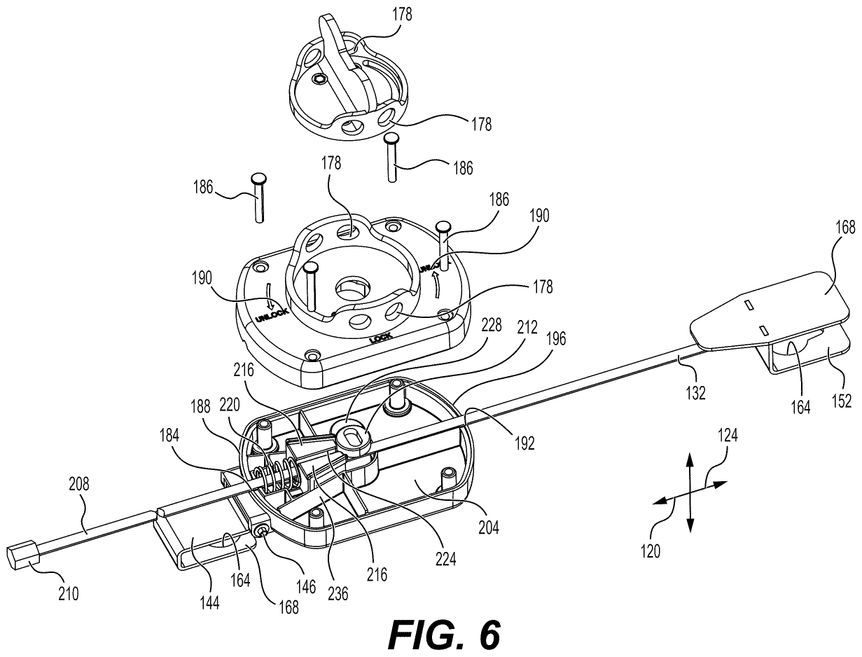

For comparison, FIG. 6 presents the lockout device 100 in the locked state. In the locked state, the lobe 228 of the cam 212 is rotated so that it is not urging the wedges 216 in the first direction 120. The spring 220 is relatively less compressed and urges the wedges 216 in the second direction 124, relative to the unlocked state. In addition, as the wedges 216 translate in the second direction 124, the interaction between the wedges 216 and walls 236 of the wedge cavity 232 urges the wedges 216 closer to each other. This, in turn, results in the opening 224 between wedges 216 becoming smaller. In this state, the opening 224 between wedges 216 is small enough that the wedges 216 have a clamping effect on the portion of the flexible cable 116 that is disposed within the opening 224 between wedges 216. The clamping effect prevents the flexible cable 116 from moving in the second direction 124, relative to the housing 112.

However, even in the locked state, the flexible cable 116 is able to move in the first direction 120, relative to the housing 112. If, for example, a user was to pull on the first end 208 of the flexible cable 116 while the lockout device was in the locked state, the flexible cable 116 is able to move relative to the housing 112 in the first direction 120. When this occurs, the engagement between the wedges 216 and the flexible cable 116 results movement of the both the flexible cable 116 and the wedges 216 in the first direction 120 when the pull on the first end 208 of the flexible cable 116 overcomes the urging force of the spring 220. This results in relative compression of the spring 220 and the translation of the wedges 216 in the first direction 120 within the wedge cavity 232. Since the wedges 216 are guided by the walls 236 of the wedge cavity 232, which are wider toward the first side 188 of the housing 112 than they are toward the second side 196 of the housing 112, the opening 224 between wedges 216 increases in size. This in turn releases the clamping effect of the wedges 216 on the flexible cable 116, therefore, allowing the flexible cable 116 to slide in the first direction 120, relative to the housing 112.

When the force urging the flexible cable 116 in the first direction 120, relative to the housing 112, is removed, the spring 220, wedges 216, and opening 224 between wedges 216 return to their initial state in which the wedges 216 clamp onto the flexible cable 116.

Conversely, when the lockout device 100 is in the locked state, a force urging the second end 132 of the flexible cable 116 will not result in movement of the flexible cable 116 in the second direction 124, relative to the housing 112. In this case, the wedges 216 are already urged in the second direction 124 by the force of the spring 220 so that the wedges 216 provide a clamping force on the flexible cable 116. Further pulling of the flexible cable 116 in the second direction 124, relative to the housing 112, results in the wedges 216 coming closer together, and, therefore, decreasing the size of the opening 224 between wedges 216. This, in turn, increases the clamping effect of the wedges 216 on the flexible cable 116 and prevents movement of the flexible cable 116 in the second direction 124, relative to the housing 112.

In this manner, when the lockout device 100 is installed onto the electrical service box 108, as shown in FIGS. 1 and 2, and is in the locked state, the flexible cable 116 may be tightened to more securely captured the door 104 but may not be loosened to less securely capture the door 104.

Still referring primarily to FIG. 6, a plurality of lock apertures 178 may be formed through the knob 140 and the front cover 176 of the housing 112. The lock apertures 178 of the knob 140 and the front cover 176 of the housing 112 may be positioned so that the lock apertures 178 of the knob 140 align with the lock apertures 178 of the front cover 176 of the housing 112 when the lockout device is in the locked state. A user may further secure the lockout device 100 to the electrical service box 108 by passing a padlock, zip tie, wire, or other security item through the aligned lock apertures 178 of the knob 140 and the front cover 176 of the housing 112. Thereby, possibly preventing the accidental or unauthorized changing of the lockout device 100 from locked to unlocked.

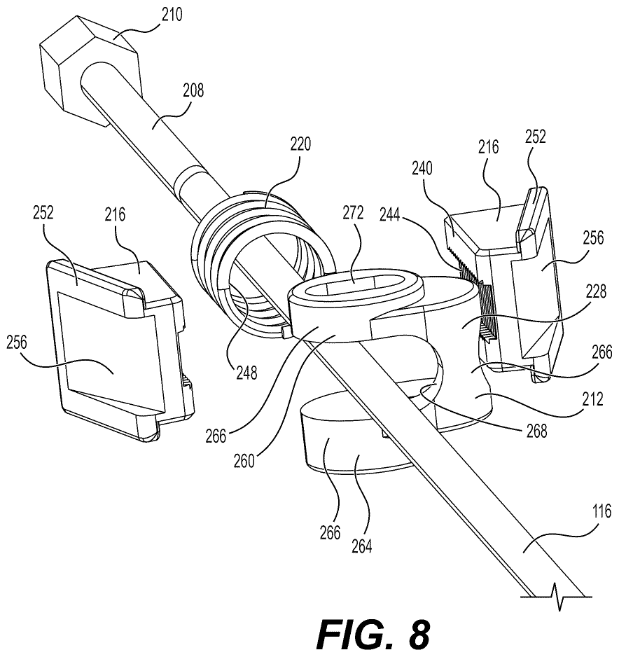

Referring now primarily to FIGS. 7 and 8, additional features of the illustrative lockout device 100 will be discussed. FIG. 7 presents an exploded view of the lockout device 100 with the flexible cable 116, spring 220, wedges 216, and cam 212 removed from the housing 112. FIG. 8 presents a detailed view of features of the flexible cable 116, spring 220, wedges 216, and cam 212.

As can be seen in FIG. 7, an interior side 240 of each wedge 216 has a textured face 244. The textured face 244 of the interior side 240 of each wedge 216 may improve the clamping effect of the wedges 216 on the flexible cable 116. In some embodiments, the textured face 244 may include a series of directional ridges that are configured to allow movement of the flexible cable 116 in the first direction 120 but decreases the ability of the flexible cable 116 to move in the second direction 124, relative to the housing 112, when the lockout device 100 is locked. In other words, the directional ridges may be formed so they bite into the flexible cable 116 when the flexible cable 116 is pulled in the second direction 124 but release the flexible cable 116 when the flexible cable 116 is pulled in the first direction 120.

As can be seen in FIG. 8, the wedges 216 may also have an outer ridge 252 and an outer angled surface 256. The outer ridge 252 and the outer angled surface 256 may be sized and shaped to conform with the walls 236 of the wedge cavity 232 (FIG. 7) to direct or improve the movement of the wedges 216 in the first direction 120 and the second direction 124 within the wedge cavity 232 of the housing 122.

As can be seen in FIGS. 7 and 8, the flexible cable 116 passes through the center 248 of the spring 220. In other configurations, the flexible cable 116 may not pass through the center 248 of the spring 220. In addition, as shown in the figures, one spring 220 is used to urge both wedges 216 in the second direction 124. In other embodiments, more than one spring 220 may be used. For example, in other embodiments, two springs 220 may be used without the flexible cable 116 passing through the springs 220 and with each spring 216 urging one of the wedges 216 in the second direction 124.

Referring still to FIGS. 7 and 8, and primarily to FIG. 8, features of the cam 212 will be discussed. As can be seen in FIG. 8, the cam 212 is sized and shaped so that the flexible cable 116 may pass through the cam 212 without interfering with the function of the cam 212 and without binding on the cam 212. The lockout device 100 may, therefore, function in both the locked and unlocked states without contact between the cam 212 and the flexible cable 116. In some embodiments, such as is shown in FIG. 8, the outer surface 266 of the cam 212 is generally smooth or untextured.

The cam 212 has an upper circular portion 260 and a lower circular portion 264, which are each coupled to the lobe 228 of the cam 212. This configuration forms a cam opening 268 through which the flexible cable 116 may pass, in both the locked and unlocked states of the lockout device 100. A cam rod aperture 272 is formed through the upper circular portion 260.

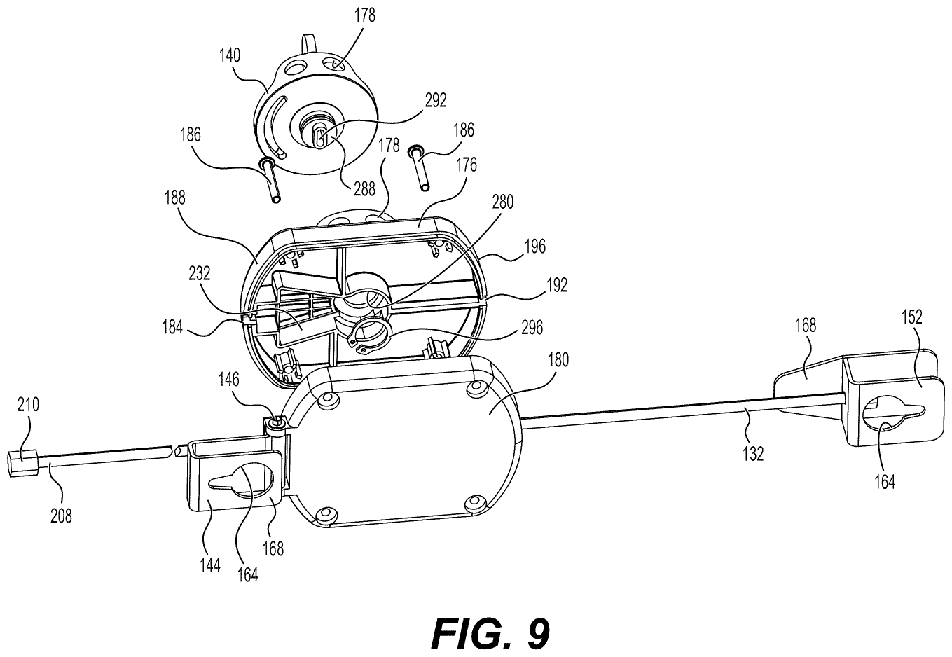

The cam rod aperture 272 is sized and configured to receive a cam protrusion 292 (FIG. 9) formed on the knob 140. In the embodiment depicted in FIG. 8, the cam rod aperture 272 and the cam protrusion 292 are ovular in shape and the cam protrusion 292 is received by and into the cam rod aperture 272. The cam protrusion 292 is retained in the cam rod aperture 272 due to a circle clip or split ring 296 (FIG. 9) retaining the rotatable knob 140 into the housing 176.

Since the cam protrusion 292 is formed on the knob 140 rotation of the knob 140 by a user also causes rotation of the cam protrusion 292. Since the cam protrusion 292 is mated with the cam rod aperture 272, the cam 212 also rotates with rotation of the knob 140. Thereby allowing a user to change the state of the lockout device 100 from locked to unlocked and vice versa.

The upper circular portion 260 of the cam 212 is sized and configured to be received by an upper cam housing 280 formed in the front cover 176 of housing 112 (FIG. 9). The lower circular portion 264 of the cam 212 is sized and configured to be received by a lower cam housing 284 formed in the back cover 180 of housing 112 (FIG. 7). Each of the upper cam housing 280 and the lower cam housing 284 is circular in shape to allow the cam 212 to be partially disposed within the upper cam housing 280 and the lower cam housing 284 and to facilitate rotation of the cam 212 inside the housing 122.

Referring now to FIG. 9, additional features of the illustrative embodiment of the lockout device 100 will be discussed. FIG. 9 presents an exploded view from below of the lockout device 100. As can be seen in FIG. 9, the knob 140 has a lower tab portion 288. The lower tab portion 288 is sized and configured to be received within the upper cam housing 280 from the exterior of the housing 112. The cam protrusion 292 is formed within the lower tab portion 288 of the knob 140. The lower tab portion 288 of the knob 140, when installed within the front cover 176 of housing 112, is retained within the upper cam housing 280 of the front cover 176 of the housing 112 by the split ring 296.

Although the present disclosure and its advantages have been disclosed in the context of certain illustrative, non-limiting embodiments, it should be understood that various changes, substitutions, permutations, and alterations can be made without departing from the scope of the disclosure as defined by the claims. It will be appreciated that any feature that is described in a connection to any one embodiment may also be applicable to any other embodiment.

What is claimed:

1-8. (canceled)

9. A lockout device for securing a door of an electrical service box, the lockout device comprising:
a housing;
a flexible cable partially disposed within the housing and slidable within the housing to allow the flexible cable to slide in a first direction and in a second direction when the lockout device is in an unlocked state;
wherein the flexible cable has a first end and a second end;
wherein, when the flexible cable slides in the first direction, a distance between the housing and the second end of the flexible cable decreases, and, when the flexible cable slides in the second direction, the distance between the housing and the second end of the flexible cable increases;
a first retainer coupled to the housing;
a second retainer coupled to the second end of the flexible cable;
two wedges disposed within the housing forming a channel between the two wedges;
wherein a portion of the flexible cable is disposed within the channel between the two wedges,
a cam disposed within the housing proximate to the two wedges for changing the state of the lockout device from a locked state to the unlocked state; and
wherein, when the lockout device is in the locked state, the flexible cable is able to slide relative to the housing in the first direction, but not in the second direction.

10. The lockout device of claim 9,
wherein the cam is rotatably disposed within the housing; and
wherein the lockout device is changed from the locked state to the unlocked state by rotation of the cam.

11. The lockout device of claim 9,
wherein each of the two wedges has a textured face; and
wherein the textured face of each of the two wedges faces the portion of the flexible cable that is disposed between the two wedges.

12. The lockout device of claim 11, wherein the textured faces of the two wedges are formed with directional ridges.

13. The lockout device of claim 11, wherein, when the lockout device is in the locked state, the portion of the flexible cable is captured by the two wedges, so that the flexible cable may only substantially move between the two wedges in the first direction relative to the housing.

14. The lockout device of claim 11, further comprising a spring disposed within the housing proximate to the two wedges, wherein the spring is operable to urge the two wedges in the second direction.

15. The lockout device of claim 11,
further comprising a spring disposed within the housing proximate to the two wedges;
wherein the spring is operable to urge the two wedges in the second direction;
wherein the cam is rotatably disposed within the housing;
wherein the lockout device is changed from the locked state to the unlocked state by rotation of the cam;
wherein each of the two wedges has a textured face;
wherein the textured face of each of the two wedge faces the portion of the flexible cable that is disposed between the two wedges; and
wherein, when the lockout device is in the locked state, the portion of the flexible cable is captured by the two wedges, so that the flexible cable may only substantially move between the two wedges in the first direction relative to the housing.

16-20. (canceled)
